(19) United States
(12) Patent Application Publication
(10) Pub. No.: US 2013/0144636 A1
(43) Pub. Date: Jun. 6, 2013

(54) Method and System for Predicting Adverse Drug Reactions Using BioAssay Data

(71) Applicants: Yannick Pouliot, San Mateo, CA (US); Annie P. Chiang, Moutain View, CA (US); Atul J. Butte, Menlo Park, CA (US)

(72) Inventors: Yannick Pouliot, San Mateo, CA (US); Annie P. Chiang, Moutain View, CA (US); Atul J. Butte, Menlo Park, CA (US)

(73) Assignee: The Board of Trustees of the Leland Stanford, Junior, University, Palo Alto, CA (US)

(21) Appl. No.: 13/309,518

(22) Filed: Dec. 1, 2011

(51) Int. Cl. G06Q 50/22

(52) U.S. Cl. 705/2

(57) ABSTRACT

An embodiment of the present invention uses logistic regression models that correlate post-marketing ADRs with screening data from the PubChem BioAssay database. These models of the present invention analyze ADRs at the level of organ systems, the System Organ Classes (SOCs). In testing to evaluate an embodiment of the present invention, nine of 19 SOCs under consideration were found to be significantly correlated with pre-clinical screening data. For six of eight established drugs for which SOC-specific adversities could be retropredicted, prior knowledge was found that support these predictions. SOC-specific adversities were then predicted for three unapproved or recently introduced drugs.

### GOVERNMENT RIGHTS

This invention was made with Government support under contract R01 GM079719 awarded by the National Institute of General Medical Sciences and contract T15 LM007033 awarded by the National Library of Medicine. The Government has certain rights in this invention.

### FIELD OF THE INVENTION

The present invention generally relates to the field of drug research. More particularly, the present invention relates to methods and systems for analyzing adverse drug reactions.

### BACKGROUND OF THE INVENTION

Pharmaceutical consumption is continuously increasing due to, among other things, the aging of the U.S. population, enhanced medication coverage, and the introduction of drugs addressing conditions previously untreatable by medications. Although beneficial, pharmaceuticals are necessarily associated with rates of morbidity and mortality. Adverse drug reactions (ADRs) are generally a response to a drug which is noxious and unintended and which occurs at doses normally used in man for prophylaxis, diagnosis, or therapy of diseases or for modification of physiological function. Serious ADRs may result in death, hospitalization, significant disability, and other permanent and life-threatening conditions. Serious ADRs are also a major clinical problem, estimated to account for more than two million incidents requiring hospitalization annually, and more than 100,000 deaths in the United States.

These statistics reflect the challenge of identifying ADRs. This is partly due to the short-duration/defined population testing paradigm of clinical trials and the difficulty of recognizing novel ADRs in patients with potentially extensive medical histories. Although progress has been made toward identifying the causes of drug-induced morbidity, the process remains difficult and haphazard, and aspects of a drug's adversity can remain obscured for years.

Many drugs exhibit unexpected organ- or body system-specific ADRs, distinct from generic ADRs involving liver or kidney damage. The advent of high-throughput molecular measurement technologies, combined with publicly-available datasets, has the potential to substantially facilitate the identification of novel ADRs in newly introduced drugs whose ADR profile is mostly unknown. Since a fraction of organ-specific ADRs is likely due to drugs interacting with unintended targets, predicting such ADRs using data from large-scale compound screening campaigns might be possible because some of the molecular actors of ADRs could involve interactions at the cellular level and may be detectable.

Although attempts at predicting ADRs using preclinical compound characteristics or screening data have been made, much progress remains to be made. Computational methods have been developed wherein pharmacovigilance data are analyzed in conjunction with a drug's structural properties to predict ADR profiles. Other methods for predicting ADRs involve testing in non-human and even yeast species but suffer from interpretability limitations due to each species' pharmacological idiosyncrasies.

There is, therefore, a need for a system and method to predict ADRs prior to market introduction using, among other things, computational approaches applied to pre-clinical data so as to inform drug labeling and marketing with respect to potential ADRs.

### SUMMARY OF THE INVENTION

Because some of the molecular actors of ADRs may involve interactions detectable in large, and increasingly public, compound screening campaigns, an embodiment of the present invention uses logistic regression models that correlate post-marketing ADRs with screening data from the PubChem BioAssay database. These models of the present invention analyze ADRs at the level of organ systems, the System Organ Classes (SOCs).

In testing to evaluate an embodiment of the present invention, nine of 19 SOCs under consideration were found to be significantly correlated with pre-clinical screening data. For six of eight established drugs for which SOC-specific adversities could be retropredicted, prior knowledge was found that support these predictions. SOC-specific adversities were then predicted for three unapproved or recently introduced drugs.

Embodiment of the present invention include computational methods for predicting adverse drug reactions in humans using publicly-available compound screening and pharmacovigilance data.

Embodiment of the present invention find application in, among other things, generating testable hypotheses for identifying unidentified adverse drug reactions in existing drugs. Embodiment of the present invention are also useful for predicting adverse drug reactions as part of the drug development process. Still other embodiments of the present invention are used for predicting adverse drug reactions in newly marketed drugs. The identification of proteins that can predict adverse drug reactions and are potentially involved in those reactions can also be achieved using embodiments of the present invention.

### BRIEF DESCRIPTION OF THE DRAWINGS

The following drawings will be used to more fully describe embodiments of the present invention.

FIG. 1 is a schematic view of a networked system on which the present invention can be practiced.

FIG. 2 is a schematic view of a computer system on which the present invention can be practiced.

FIG. 3 is a flowchart of a method according to an embodiment of the present invention.

FIG. 4 is a graph showing regression p-values for BioAssays evaluated by a method according to an embodiment of the present invention.

FIGS. 5A and 5B are graphs that show the selectivity and specificity for the top two best performing models where 5A graphs a model for “Immune system disorders” SOC and 5B graphs a model for “Blood and lymphatic system disorders” SOC.

FIG. 6 is a table that presents summary properties of logistic regression models according to an embodiment of the present invention.

FIG. 7 is a table of FDA-approved drugs predicted to manifest unrecognized adversity according to an embodiment of the present invention.

FIG. 8 is a table of predicted SOC-specific adversity for novel or recently approved drugs according to an embodiment of the present invention.

FIG. 9 is a 2×2 contingency table used to calculate PRR according to an embodiment of the present invention.

FIG. 10 is a table of usable CVAR drug ingredients in PubChem BioAssay according to an embodiment of the present invention.

FIG. 11 is a table of the number of ADRs per SOC in CVAR according to an embodiment of the present invention.

FIG. 12 is a mapping of PubChem SIDs to UMLS, PubChem BioAssay and CVAR according to an embodiment of the present invention.

FIG. 13 is a table of PubChem Substance SIDs mapped to CVAR drug ingredients according to an embodiment of the present invention.

FIG. 14 is a table of properties of usable BioAssays according to an embodiment of the present invention.

### DETAILED DESCRIPTION OF THE INVENTION

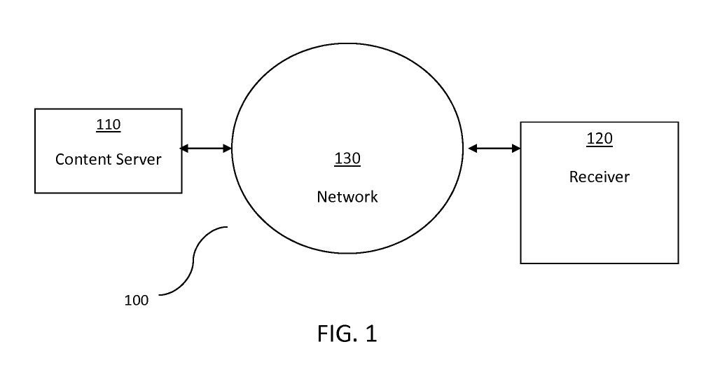

Among other things, the present invention relates to methods, techniques, and algorithms that are intended to be implemented in a digital computer system. By way of overview that is not intended to be limiting, digital computer system 100 as shown in FIG. 1 will be described. Such a digital computer or embedded device is well-known in the art and may include variations of the below-described system.

Those of ordinary skill in the art will realize that the following description of the present invention is illustrative only and not in any way limiting. Other embodiments of the invention will readily suggest themselves to such skilled persons, having the benefit of this disclosure. Reference will now be made in detail to specific implementations of the present invention as illustrated in the accompanying drawings. The same reference numbers will be used throughout the drawings and the following description to refer to the same or like parts.

Further, certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of functions.

The term “machine-readable medium” should be understood to include any structure that participates in providing data which may be read by an element of a computer system. Such a medium may take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium.

FIG. 1 depicts an exemplary networked environment 100 in which systems and methods, consistent with exemplary embodiments, may be implemented. As illustrated, networked environment 100 may include a content server 110, a receiver 120, and a network 130. The exemplary simplified number of content servers 110, receivers 120, and networks 130 illustrated in FIG. 1 can be modified as appropriate in a particular implementation. In practice, there may be additional content servers 110, receivers 120, and/or networks 130.

In certain embodiments, a receiver 120 may include any suitable form of multimedia playback device, including, without limitation, a computer, a gaming system, a smart phone, a tablet, a cable or satellite television set-top box, a DVD player, a digital video recorder (DVR), or a digital audio/video stream receiver, decoder, and player. A receiver 120 may connect to network 130 via wired and/or wireless connections, and thereby communicate or become coupled with content server 110, either directly or indirectly. Alternatively, receiver 120 may be associated with content server 110 through any suitable tangible computer-readable media or data storage device (such as a disk drive, CD-ROM, DVD, or the like), data stream, file, or communication channel.

Network 130 may include one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, and/or another type of suitable network, depending on the requirements of each particular implementation.

One or more components of networked environment 100 may perform one or more of the tasks described as being performed by one or more other components of networked environment 100.

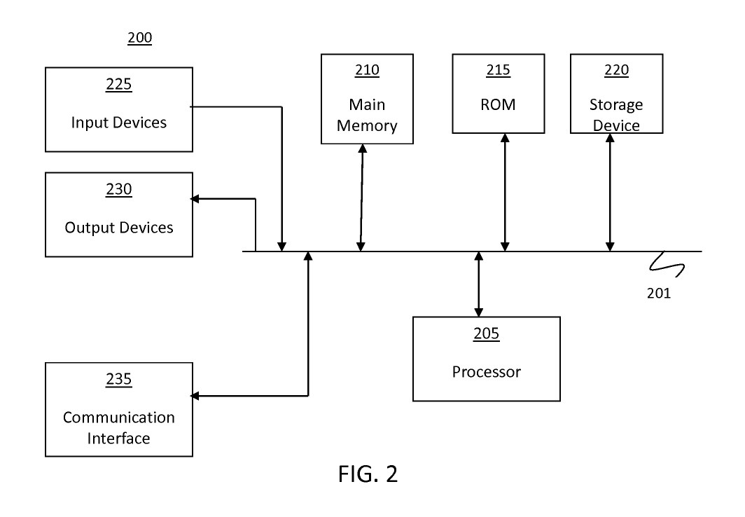

FIG. 2 is an exemplary diagram of a computing device 200 that may be used to implement aspects of certain embodiments of the present invention, such as aspects of content server 110 or of receiver 120. Computing device 200 may include a bus 201, one or more processors 205, a main memory 210, a read-only memory (ROM) 215, a storage device 220, one or more input devices 225, one or more output devices 230, and a communication interface 235. Bus 201 may include one or more conductors that permit communication among the components of computing device 200.

Processor 205 may include any type of conventional processor, microprocessor, or processing logic that interprets and executes instructions. Moreover, processor 205 may include processors with multiple cores. Also, processor 205 may be multiple processors. Main memory 210 may include a random-access memory (RAM) or another type of dynamic storage device that stores information and instructions for execution by processor 205. ROM 215 may include a conventional ROM device or another type of static storage device that stores static information and instructions for use by processor 205. Storage device 220 may include a magnetic and/or optical recording medium and its corresponding drive.

Input device(s) 225 may include one or more conventional mechanisms that permit a user to input information to computing device 200, such as a keyboard, a mouse, a pen, a stylus, handwriting recognition, voice recognition, biometric mechanisms, and the like. Output device(s) 230 may include one or more conventional mechanisms that output information to the user, including a display, a projector, an A/V receiver, a printer, a speaker, and the like. Communication interface 235 may include any transceiver-like mechanism that enables computing device/server 200 to communicate with other devices and/or systems. For example, communication interface 235 may include mechanisms for communicating with another device or system via a network, such as network 130 as shown in FIG. 1.

As will be described in detail below, computing device 200 may perform operations based on software instructions that may be read into memory 210 from another computer-readable medium, such as data storage device 220, or from another device via communication interface 235. The software instructions contained in memory 210 cause processor 205 to perform processes that will be described later. Alternatively, hardwired circuitry may be used in place of or in combination with software instructions to implement processes consistent with the present invention. Thus, various implementations are not limited to any specific combination of hardware circuitry and software.

A web browser comprising a web browser user interface may be used to display information (such as textual and graphical information) on the computing device 200. The web browser may comprise any type of visual display capable of displaying information received via the network 130 shown in FIG. 1, such as Microsoft's Internet Explorer browser, Google's Chrome browser, Mozilla's Firefox browser, PalmSource's Web Browser, Google's Chrome browser or any other commercially available or customized browsing or other application software capable of communicating with network 130. The computing device 200 may also include a browser assistant. The browser assistant may include a plug-in, an applet, a dynamic link library (DLL), or a similar executable object or process. Further, the browser assistant may be a toolbar, software button, or menu that provides an extension to the web browser. Alternatively, the browser assistant may be a part of the web browser, in which case the browser would implement the functionality of the browser assistant.

The browser and/or the browser assistant may act as an intermediary between the user and the computing device 200 and/or the network 130. For example, source data or other information received from devices connected to the network 130 may be output via the browser. Also, both the browser and the browser assistant are capable of performing operations on the received source information prior to outputting the source information. Further, the browser and/or the browser assistant may receive user input and transmit the inputted data to devices connected to network 130.

Similarly, certain embodiments of the present invention described herein are discussed in the context of the global data communication network commonly referred to as the Internet. Those skilled in the art will realize that embodiments of the present invention may use any other suitable data communication network, including without limitation direct point-to-point data communication systems, dial-up networks, personal or corporate Intranets, proprietary networks, or

In an embodiment of the present invention, a large, publicly-available compilation of heterogeneous, pre-clinical molecular screening assays were used to determine whether drug bioactivity across vast screens correlates with post-marketing ADRs manifesting in specific System Organ Classes (SOCs). SOCs are used to group types of ADRs according to where they manifest in the body as defined by the Medical Dictionary for Regulatory Activities (MedDRA). For example, “eosinophilia” as a side-effect of drug treatment is listed under “Blood and lymphatic system disorders” SOC.

In an embodiment, a drug's propensity toward SOC-specific ADRs was correlated, as calculated from the Canadian Adverse Drug Reaction (CVAR) pharmacovigilance database, with patterns of screening activity observed in the National Center for Biotechnology Information's PubChem BioAssay database. A component of the National Institutes of Health (NIH)'s Molecular Libraries Initiative, PubChem BioAssay currently stores data from more 487,000 screens involving hundreds of thousands of compounds across thousands of molecular targets that enables analyses previously available only to pharmaceutical companies.

Using these molecular screening assay data in an embodiment of the invnetion, statistical models were created for nine of 19 SOCs under consideration. Using an embodiment of the invention, these were then used to predict unrecognized ADRs for drugs currently or recently approved in the United States as well as drugs not yet marketed in the United States.

Methods

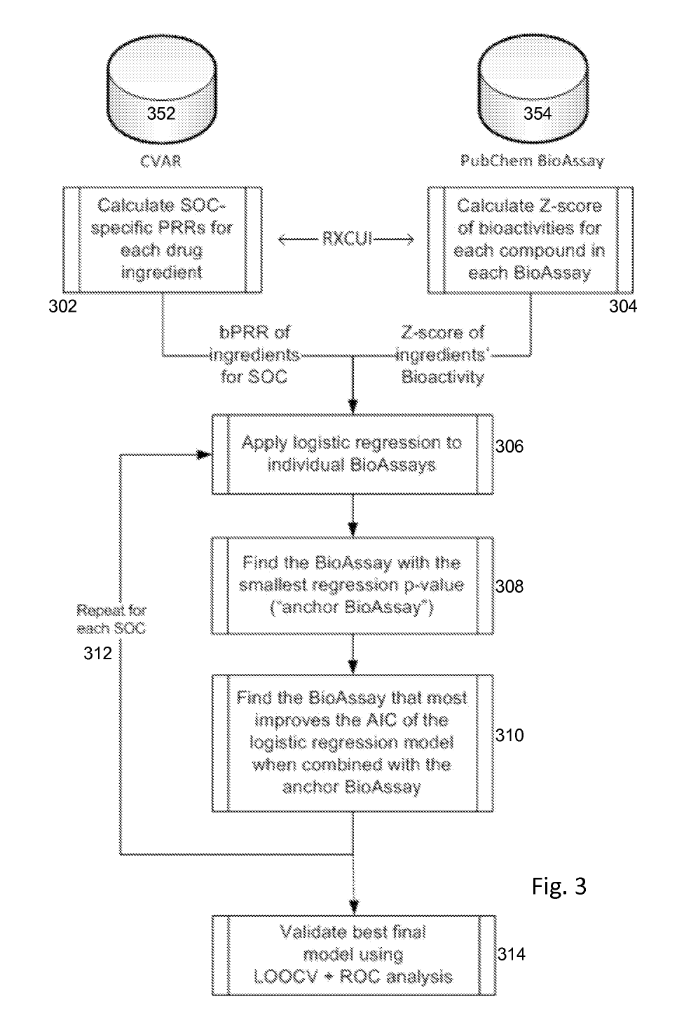

The analytical pipeline of an embodiment of the present invention searched across 485 drug ingredients in 508 BioAssays in PubChem to identify potential unrecognized adverse drug reactivities manifesting in specific System of Organ Classes (SOCs) (see FIG. 3).

Shown in FIG. 3, is a method according to an embodiment of the present invention for an analytical pipeline that uses a set of integrated databases to correlate a drug's pre-clinical, publically-available screening bioactivity with its pharmacovigilance adversity. The pipeline shown in FIG. 3 seeks drug screening bioactivities that correlate with the drug's adversity in individual SOCs as calculated by logistic regression models applied to bioactivity and SOC-specific PRR. For each SOC, the model with the best regression p-value was selected, and its selectivity and specificity assessed.

As shown, using CVAR data at step 302, the method of FIG. 3 calculates SOC-specific proportional reporting ratios (PRRs) for each ingredient of a drug of interest. Among other things, the PRRs provide information on how an adversity profile differs from one drug to another.

In an embodiment, post-marketing adverse drug reaction data were obtained from CVAR on Mar. 29, 2010 and loaded into a MySQL relational database (Oracle Corporation, Redwood Shores, Calif.). At that time, CVAR held spontaneously reported ADRs in Canada from 1965 to 2009. Drug reactions collected in pharmacovigilance databases cannot usually be attributed definitively to a drug and are generally presumed to be valid by the analytical pipeline of an embodiment of the present invention.

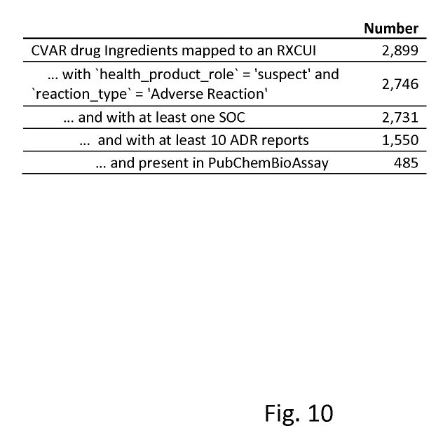

CVAR drug ingredient names were assigned a UMLS unique concept identifier for drugs (“RXCUI”) to cross-reference compounds across databases. 2,899 drug ingredients listed in CVAR were assigned an RXCUI with 485 RXCUIs mapped to compounds in the PubChem BioAssay database (see table of FIG. 10) associated with 1,498,570 presumed adverse drug reactions. Drug ingredients were not filtered according to type of molecule, such as small molecules and biologics.

CVAR relies upon the Medical Dictionary for Regulatory Activities (MedDRA) to group ADRs based on the tissues and organs where they manifest, the System of Organ Classes (SOC). Analyzing ADRs at the level of a SOC improves the detectability of signals in a manner consistent with how ADRs manifest in clinical practice.

In an embodiment, after merging the “Immune system disorders” SOC into the “Infections and infestations” SOC and excluding the SOCs “Injury, poisoning and procedural complications”, “Investigations”, “Social circumstances” and “Surgical and medical procedures”, 19 SOCs were found associated with ADRs meeting the present requirements.

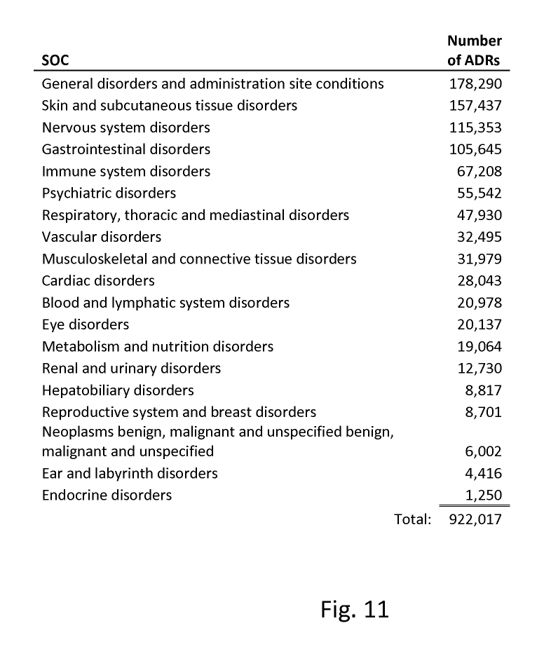

In an embodiment, ADRs had to meet three requirements to participate in the calculation of a drug's SOC-specific PRR (described below): (1) association with a SOC; (2) be of type “adverse reaction” and of class “suspect”; (3) have a minimum of 10 reports associated with the drug ingredient. Several ADRs may be associated with a single report, possibly associated with different SOCs. These requirements ensure that SOC-specific PRRs are calculated on a meaningful number of ADRs for which the drug ingredient is the suspected causative agent. Between 1,250 and 178,290s ADRs per SOC were identified in this way (see table of FIG. 11).

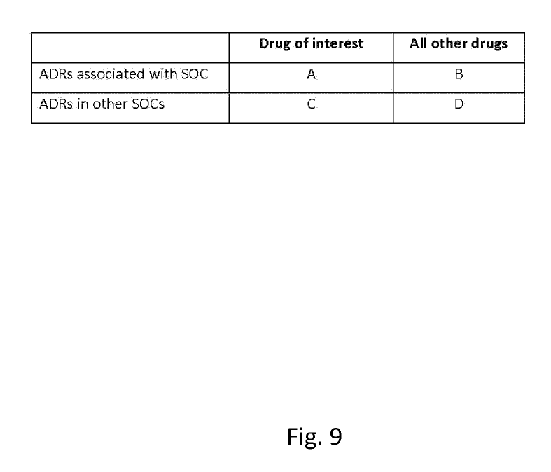

PRR was used to assess a compound's propensity toward adverse reaction. This metric is based upon the ratio of the relative frequency of reactions of a given type as compared with all other types of reactions for a drug, and the frequency of reactions of that type for all other drugs in the database. The “SOC-specific PRR” of all drugs was calculated by pooling a drug's ADRs into those SOCs in which they manifest clinically as per equation (2), using the terms defined in the table of FIG. 9.

PRR=[A/(A+C)]/[B/(B+D)] (2)

For logistic regression, SOC-specific PRRs were binarized (“BPRR”) according to equation (3):

$$Binarized P R R = \{ \begin{matrix}0 , P R R < 2 \\ 1 , P R R \geq 2\end{matrix} \qquad ( 3 )$$

The PRR threshold of 2 used here is generally assumed to indicate meaningful potential for adverse drug reactivity. Compounds without ADRs in a particular SOC were assigned a SOC-Specific PRR of 0 if at least 10 ADR reports involving ADRs in other SOCs were present. As shown in FIG. 3, the output of step 302 is bPRR (binarized PRR) of ingredients for each SOC.

At step 304, Z-scores of bioactivities are calculated for each compound in each BioAssay of interest. Among other things, the calculated Z-scores provide a measure for the activity level of the various compounds in a given assay.

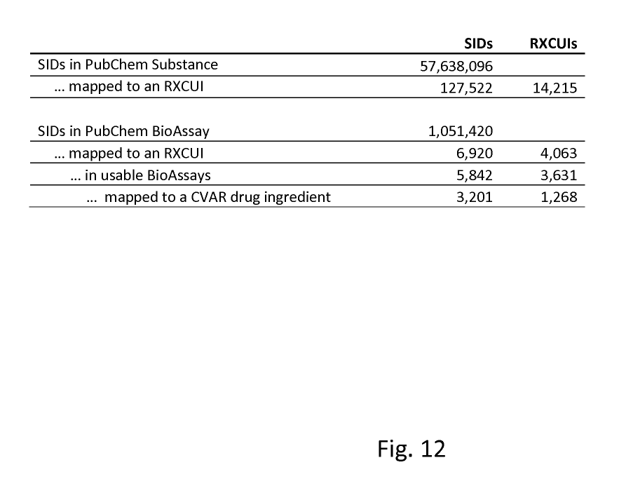

Screening bioactivity data were obtained from PubChem's BioAssay database on Apr. 1, 2010 and converted into a MySQL database. At that time, the database contained BioAssays involving 466 molecular targets, as well as BioAssays without defined targets (e.g., cytotoxicity assays), involving more than one million Substance Identifiers (SIDs) (see table of FIG. 12).

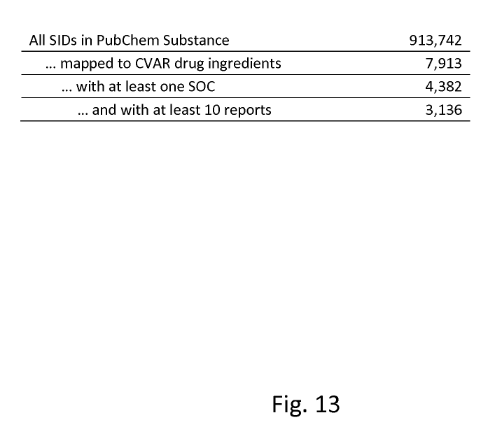

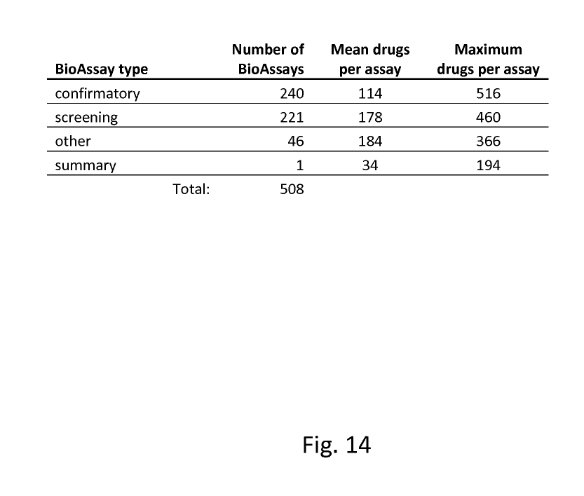

The process of mapping SIDs to drug ingredients in CVAR is described in the table of FIG. 13. Informative BioAssays were selected based on the steps described in the table of FIG. 14

PubChem BioAssay's Activity Scores of compounds within each BioAssay were normalized to a Z-score according to equation (1):

$$Z = \frac{x - μ}{σ} \qquad ( 1 )$$

where x is the Activity Score of the compound, and μ and σ are the average and standard deviation of the Activity Score for all compounds associated with the BioAssay, respectively. Raw activity measurements and depositor-submitted activity assessments stored in PubChem BioAssay (“Outcome”) were not used.

As shown in FIG. 3, the output of step 304 is a Z-scores of bioactivities for each compound in each BioAssay.

Identifiers from the Unified Medical Language System (UMLS), version 2007AC, were used to uniquely identify entities in the PubChem BioAssay, Substance, CVAR and DrugBank databases, as described below.

As shown in FIG. 3, at step 306, the method of FIG. 3 applies logistic regression of every SOC-specific PRRs of every ingredient of a drug against activities of every individual BioAssay. Since the number of CVAR drug ingredients shared between BioAssays decreases very rapidly as BioAssays are intersected, a forward- or backward-stepwise predictor selection in which all predictors (BioAssays) are evaluated together could not be performed. Instead, the construction of the logistic regression model was performed in two steps.

First, the BioAssay with the most significant univariate logistic regression coefficient was identified (“anchor assay”) at step 308. This is followed by the second most significant BioAssay as shown at step 310 that, when added to the model, most improved the Akaike's Information Criterion (AIC) of the resulting model without unduly impacting the significance of the anchor assay. For models with dual BioAssays, no interaction was assumed between them, and drugs must be present in both BioAssays.

To avoid potentially biasing models toward BioAssays with structurally related compounds, the Tanimoto coefficient was calculated for drug ingredients composing a model by evaluating all pairs of drugs for a Tanimoto coefficient ≧0.9. In a few instances a small fraction of a model's drugs satisfied this threshold (<10%). These were evaluated to determine whether they could bias the model by being overly associated with specific features within the model, for example, BPRR=1, or Z-score ≧2. No such over-representation was observed in models of the present invention.

As shown for the method of FIG. 3, steps 306 through 310 are repeated for each SOC (see branch 312).

At step 314, the generated model is validated. In an embodiment of the invention, a leave-one-out cross validation (LOOCV) and Receiver Operating Characteristic (ROC) methods were implemented, but those of ordinary skill in the art will understand that other validation methods can also be used. In step 314, individual drug ingredients were removed from the dataset, the model re-computed and evaluated using the ROCR module. This process was repeated for all drug ingredients within the model, and the average ROC AUC, regression coefficient, and p-value were generated for each SOC.

Screening Target Specificity

The target specificity of compounds screened in the models' BioAssays was assessed by comparing the known molecular interactors of a compound with the target associated with the BioAssay as stated by PubChem. DrugBank's drug-target associations were used for this purpose. Comparisons were made using GenBank GI numbers and target names.

Prediction of Unrecognized ADRs in Marketed Drug Ingredients

As a test of the predictive power of the present invention, drug ingredients were sought to be identified with unrecognized ADRs using models with ROC AUC≧0.7. Ingredients meeting three requirements were selected: largest logistic probability of high PRR (LPHPRR), LPHPRR≧0.5, but observed PRR<2. In the models, an LPHPRR≧0.5 indicates a compound predicted to exhibit a PRR≧2.

Three sources were consulted to determine prior association of the selected drug ingredient with the predicted SOC: the U.S. FDA drug label (DailyMed); the Warnings and Adverse Effects sections of each ingredient's record in the DRUGDEX database, a compilation of drug data and knowledge derived from the literature and regulatory agencies; and the FDA's MedWatch database. Types of ADRs equivalent to the MedDRA Primary Terms linked to the SOC predicted to be associated with the drug ingredient were taken to indicate that the ingredient was already known to be associated with that SOC.

ADR Prediction for Novel Drugs

An embodiment of the present invention was tested for the ability to predict adverse drug reactions in novel medications with limited or no known post-marketing adversity. Four conditions were applied for a drug ingredient to be considered “novel”: (1) not approved by the FDA at the time of writing, or approved within the past ten years; (2) included in an ongoing clinical trial as listed in ClinicalTrials.gov as of October 2010; (3) not included in the CVAR data set used to train the models due to lack of ADR reports; (4) present in the set of compounds screened in the BioAssays associated with a model. The bioactivity of novel ingredients was used to calculate the LPHPRR using models with ROC AUC≧0.7. For each SOC, the drug ingredient with the best LPHPRR and LPHPRR≧0.5 was retained. Predictions were assessed against prior knowledge according to the process described above, as well as searches in PubMed and EMBASE.

Results

For each drug, the pipeline applied logistic regression to seek individual or pairs of BioAssay bioactivities that optimally correlate with increased drug adversity in specific SOCs as measured by the Proportional Risk Ratio (PRR) metric. In an embodiment, drugs with a SOC-specific PRR≧2 were considered as especially prone to ADRs in that SOC.

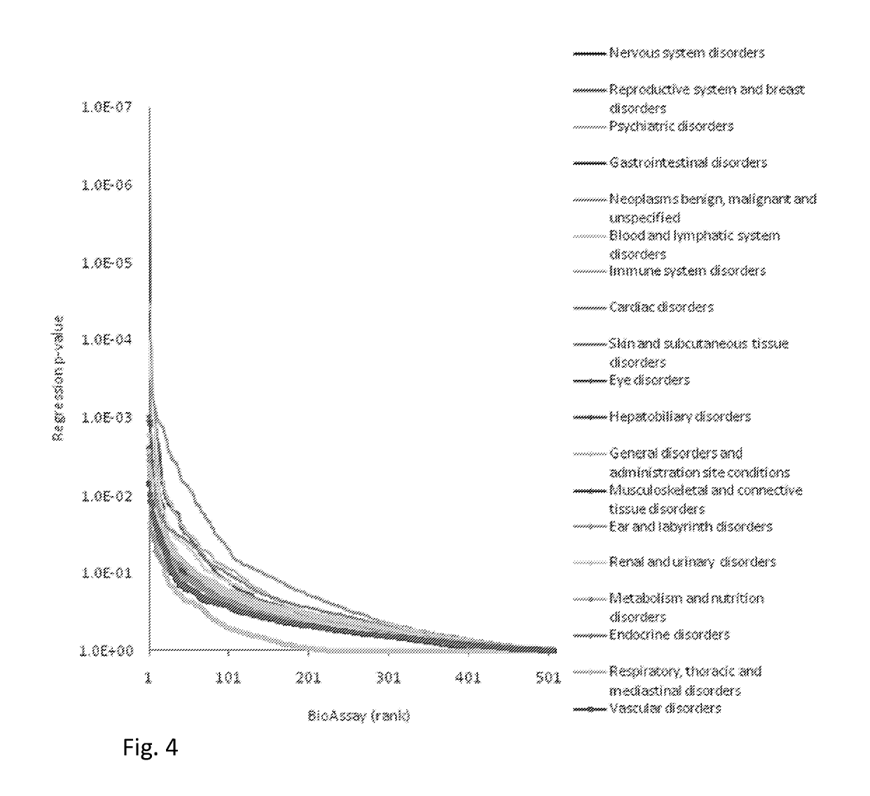

For each SOC, BioAssays were first ranked based on the p-value of the logistic regression between a drug's binarized SOC-specific PRR and its screening bioactivity (See FIG. 4). BioAssays with the most significant p-values that most improved Akaike's Information Criterion (AIC) when combined into a single regression equation were selected to compose the SOC's model. In an embodiment, a total of 19 univariate or bivariate logistic regression models were generated in this way, one for each SOC grouping of adverse reactions, trained on as many drug ingredients as possible.

These models were evaluated using leave-one-out-cross-validation (LOOCV), which removes one drug ingredient from the dataset and uses the model to predict whether that drug had a significantly high PRR or not. The model's performance is then assessed using Receiver Operating Characteristic (ROC) analysis, and the process is repeated for all drug ingredients within the model.

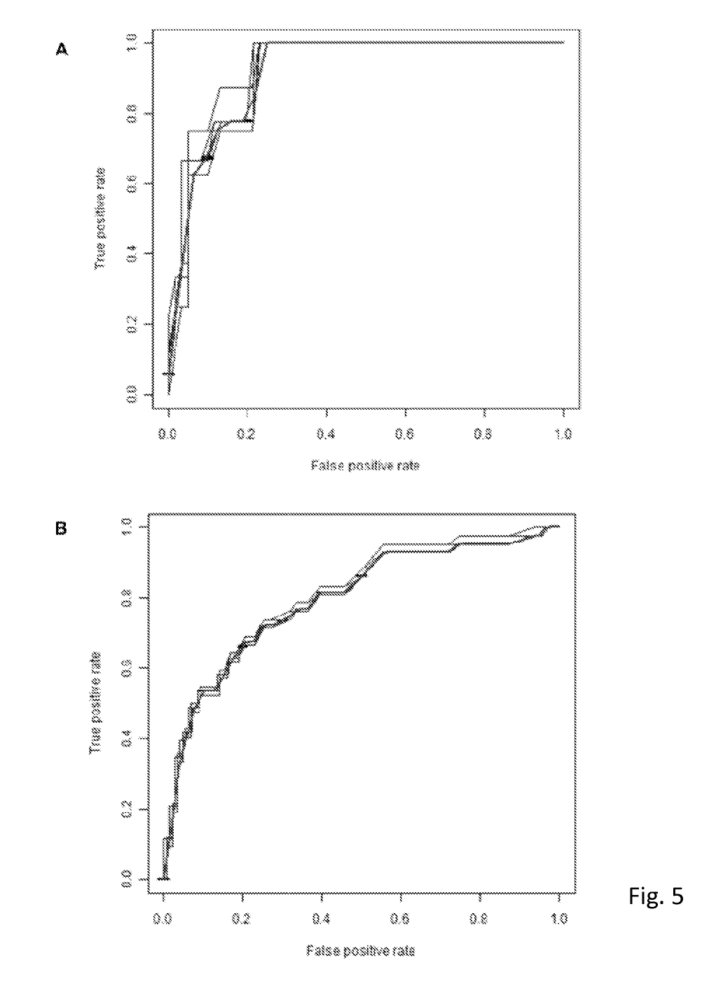

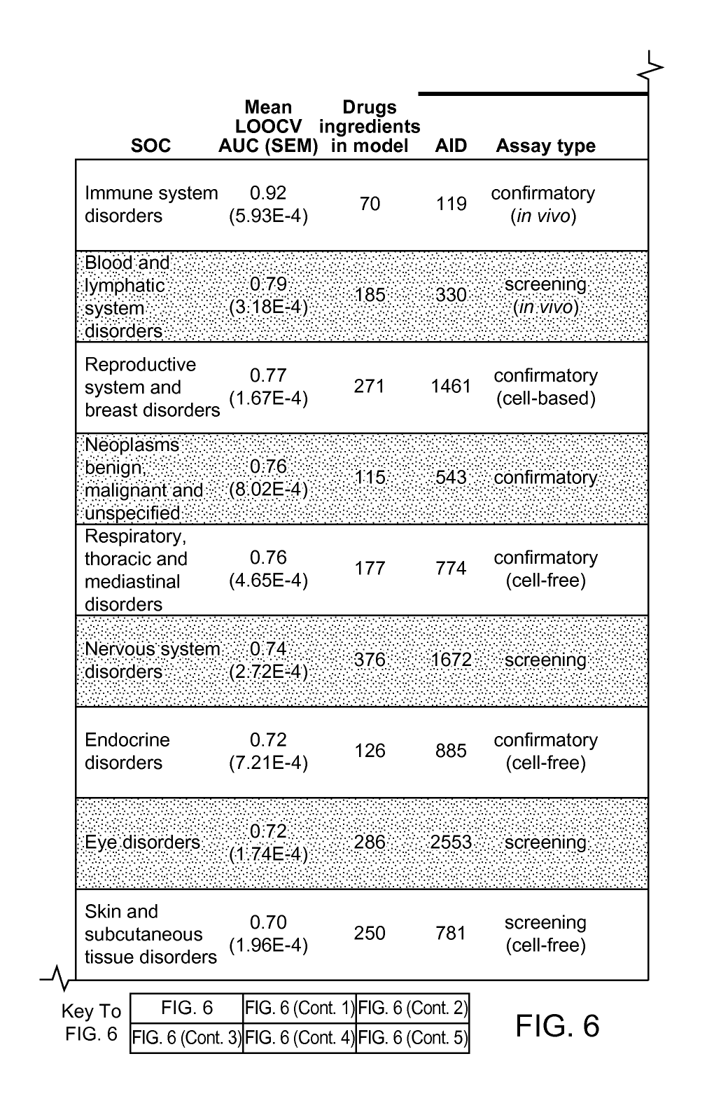

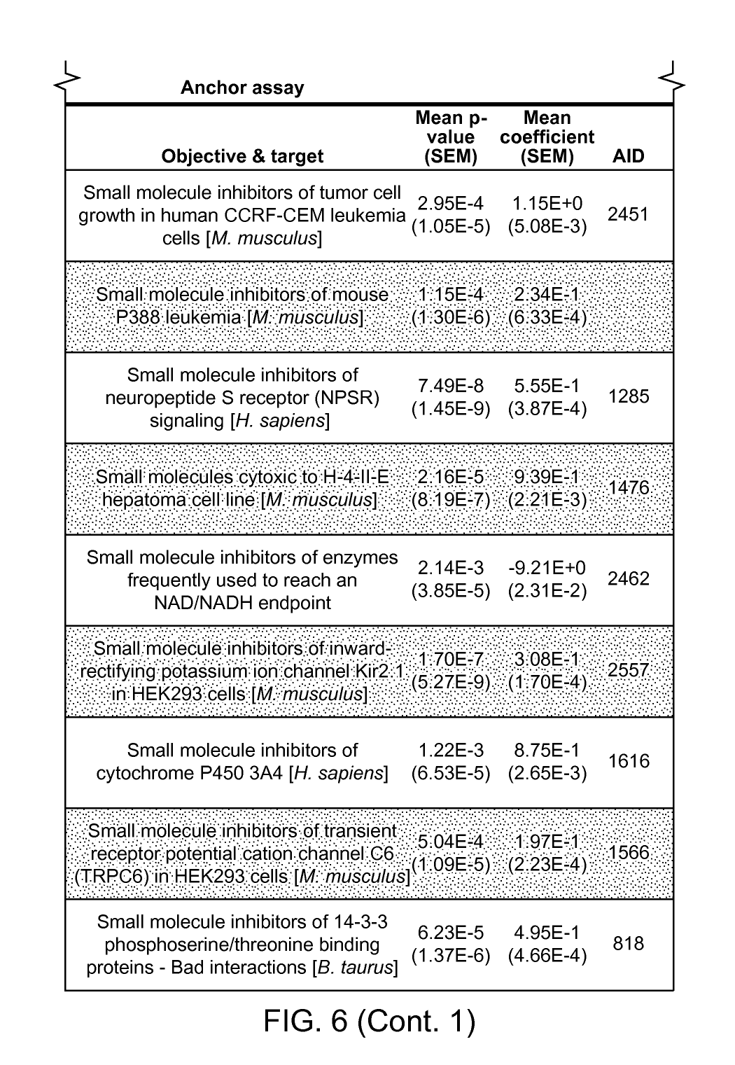

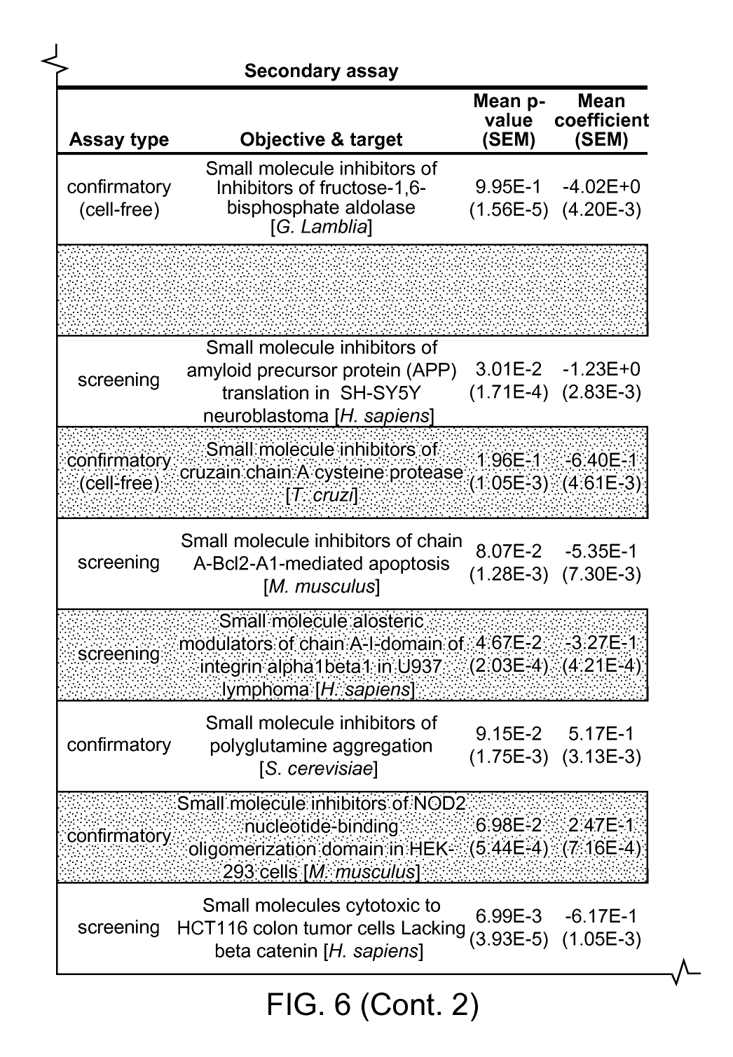

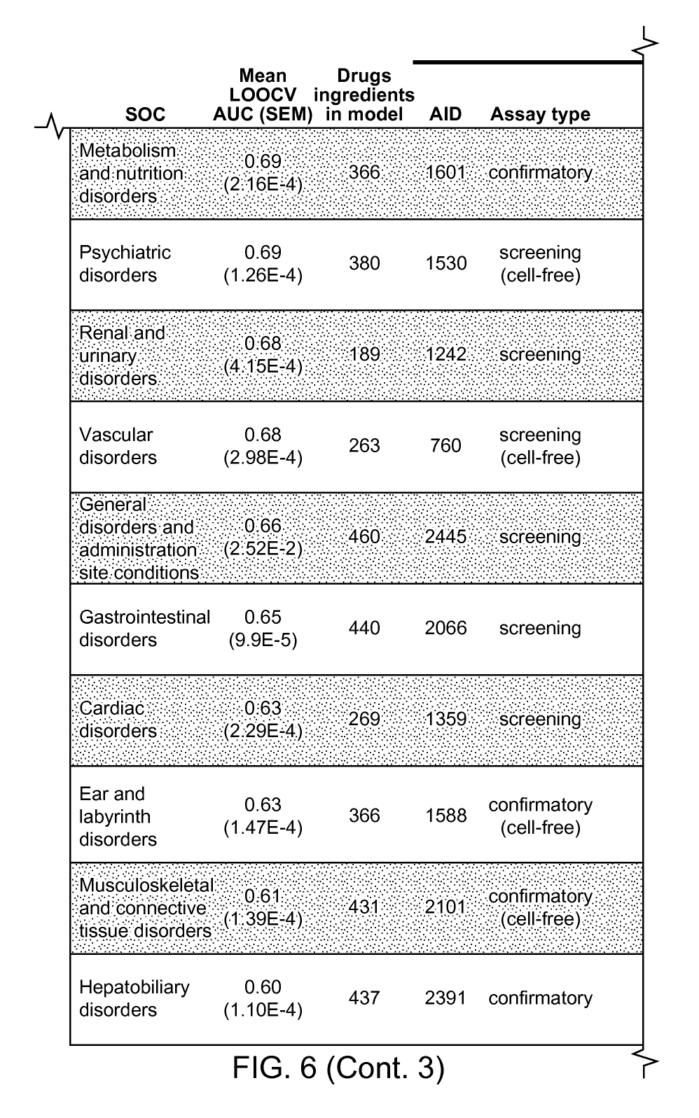

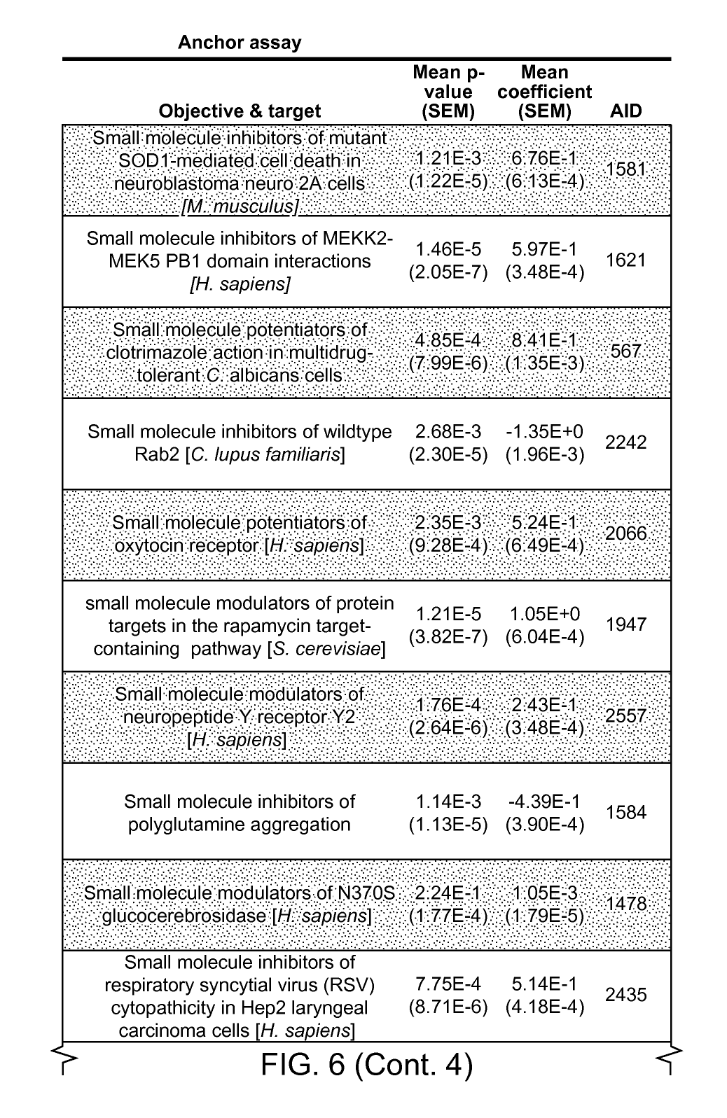

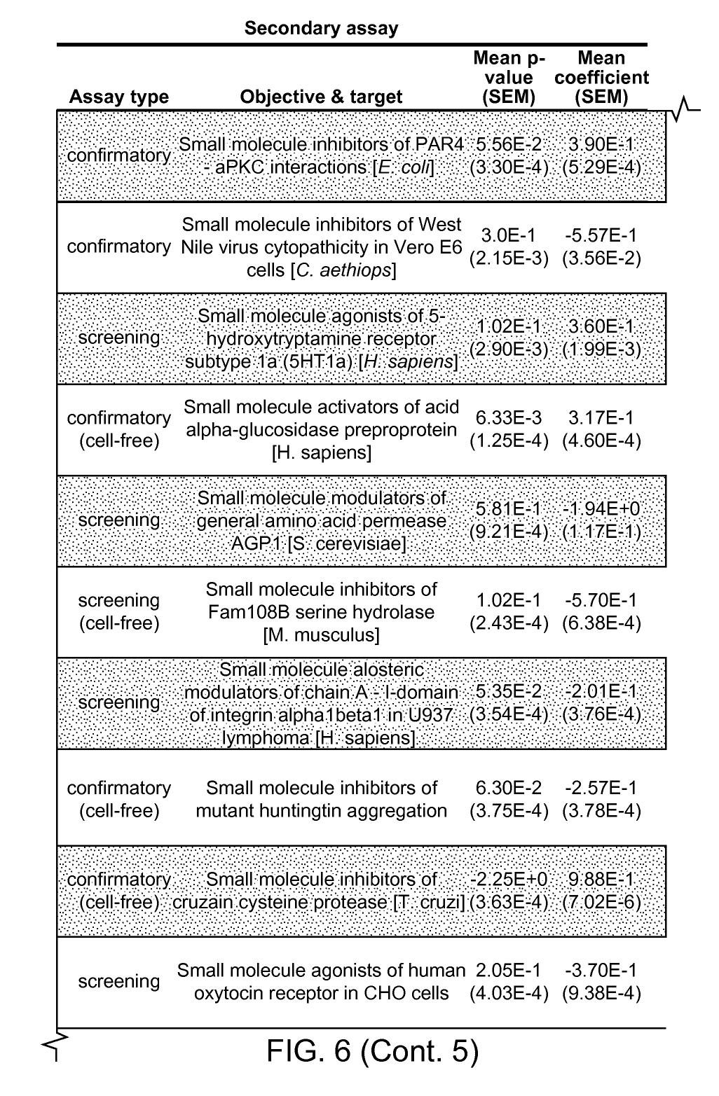

The mean Area Under the Curve (AUC), regression coefficient and p-value are then computed in an embodiment of the present invention. The mean p-value of recomputed LOOCV regression models ranged from 10-2 to 10-8, with mean AUCs ranging from 0.60 to 0.92 (see table of FIG. 6). Nine models (47%) had AUC values of 0.7 or better (see table of FIG. 6). The ROC curves for the best two models, “Immune system disorders” (LOOCV mean AUC=0.92) and “Blood and lymphatic system disorders” (LOOCV mean AUC=0.79), are depicted in FIGS. 5A and 5B, respectively.

Models in an embodiment of the present invention encompass between 70 and 437 drug ingredients per model with most models relying on BioAssays that interrogate defined molecular targets (see table of FIG. 6). Of the 37 BioAssays selected by the pipeline in an embodiment of the present invention, two were assigned to more than one SOC: AID2066 was found to be predictive in SOCs “Gastrointestinal disorders” and “General disorders and administration site conditions”, whereas AID2557 was predictive in the “Nervous system disorders” and the “Cardiac disorders” SOCs.

Most of the BioAssays in the models of an embodiment of the present invention were performed by members of the NIH Molecular Library Screening Center Network or the NIH Molecular Libraries Probe Production Centers Network. These BioAssays were roughly divided across the screening (single compound concentration testing) and confirmatory (multiple compound concentration testing) categories. The two best performing models involve screens performed in vivo: AID 119 (“Immune system disorders” SOC) and AID330 (“Blood and lymphatic system disorders” SOC), respectively. AID119 seeks small molecules growth inhibitors of CCRF-CEM leukemia cells, a human acute lymphoblastic leukemia cell line. AID330 seeks small molecule inhibitors of tumor growth or survival for mouse P388 leukemia cells in vivo, a model of leukemia. Also notable is the selection of 13 BioAssays (46% of selected BioAssays) that measure biochemical activity in a cell-free context (see table of FIG. 6).

For those screens with defined targets (78% of selected BioAssays), almost none of the molecular targets of the drugs used to train the models in an embodiment are the same as the targets of the BioAssays learned for a given model.

Predictions for Marketed Drugs

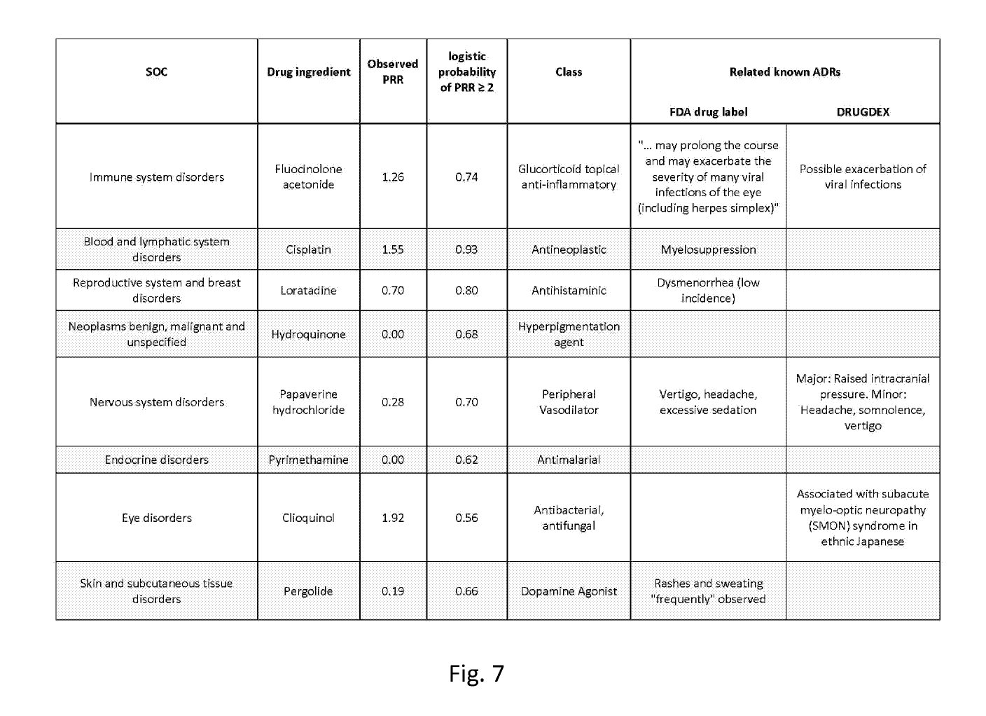

Retropredictive evaluation was performed for these models of the present invention using the individual drugs encompassed in these models. Models with a ROC AUC≧0.7 were used to calculate the logistic probability of high PRR (LPHPRR) for individual drugs within a model. For each model, the selected drug ingredient was the one with the largest LPHPRR for which the present inventions prediction of PRR≧2 did not match its current PRR<2 as calculated from CVAR pharmacovigilance data. These are drug ingredients for which a high PRR is predicted by an embodiment of the present invention but for which a low SOC-specific PRR is calculated using conventional reporting methods. Using an embodiment of the present invention, potential unrecognized SOC-specific ADRs were predicted for eight drugs with LPHPRR ranging from 0.56 for the “Eye disorders” SOC to 0.93 for the “Blood and lymphatic system disorders” SOC (See table of FIG. 7).

These predictions of SOC-specific ADRs were then assessed by reviewing a database compendium of the literature, as well as each drug's label. For five of the eight compounds (63%), mentions were found of adverse drug reactions in the FDA's drug label that are associated with the SOC under consideration (see table of FIG. 7). For example, a model of the present invention predicts a high PRR for cisplatin for the “Blood and lymphatic system disorders” SOC that did not match the lower calculated PRR given conventional reporting in CVAR. But the label for cisplatin itself lists myelosuppression as a “black box” warning, a type of ADR classified under SOC (see table of FIG. 7). The label's warning may have inhibited post-marketing adversity reporting of this ADR to regulatory agencies, a known source of under-reporting that can lead to a lower PRR.

Evidence of SOC-specific adversity was found in the DRUGDEX database for the sixth ingredient, clioquinol. This anti-fungal agent, predicted to create adversity in the “Eye disorders” SOC, is already known to be associated with subacute myelo-optic neuropathy (SMON) syndrome in ethnic Japanese (see table of FIG. 7).

Prior knowledge of carcinogenicity could not be found for the skin bleaching agent hydroquinone in humans, as predicted by a model of the present invention. Hydroquinone is known to belong to a small group of drugs with genotoxic carcinogenic activity in in vivo murine bone marrow micronucleus tests but not in in vitro mutagenesis tests such as the Ames test.

Similarity, prior knowledge could not be found for the predicted endocrine SOC-specific adversity for the antimalarial drug pyrimethamine, and suggest this as a potentially novel or unreported class of ADRs for this drug. Overall, for an embodiment of the present invention, 75% of the predictions of adversity in humans could be substantiated by the literature or the drug's label.

Predictions for Novel or Recently Approved Drugs

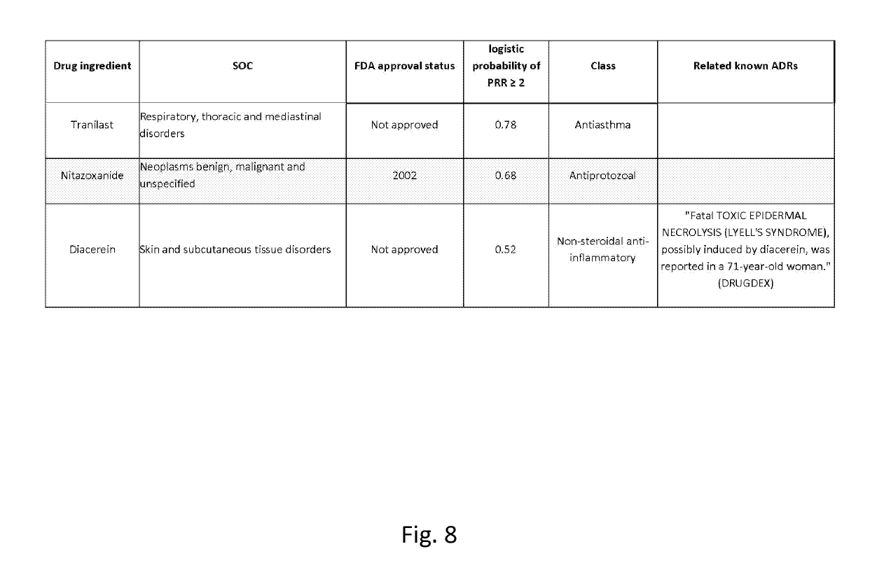

Models of another embodiment of the present invention were further applied to predict adversity for novel or recently approved drugs not present in the CVAR data set used to train the models of the present invention. Three compounds were found to meet the present requirements for novelty, presence in the models' BioAssays, and being investigated by ongoing clinical trials: tranilast, nitazoxanide and diacerein (see table of FIG. 8). Of these three, nitazoxanide is the only FDA-approved drug (approved in 2002).

In an embodiment, adversity is predicted for diacerein within the “Skin and subcutaneous tissue disorders” SOC. This embodiment found one supporting literature report pertaining to this prediction (see table of FIG. 8), wherein diacerein has been anecdotally associated with a single fatal case of toxic epidermal necrolysis, a type of ADR included in this SOC. Prior knowledge could not be found for predictions of respiratory system disorders for tranilast, and induction of neoplasms for nitazoxanide.

This analysis demonstrates how drugs characterized by an increased frequency of ADRs in specific SOCs can potentially be detected using patterns of biological activity from qualitatively different screens, such as screens evaluating in vivo cytotoxicity, bioactivity in cell culture, or molecular interactions in cell-free biochemical assays (Table 1).

The present invention demonstrates that post-marketing adverse drug reactions can be correlated with data from diverse, publicly-available preclinical biological assays, building from previous work using proprietary, univariate databases. Along with recent computational approaches based on functional profiling, docking, compound structure, and integrated data sets, the present results demonstrate the potential for the identification of hitherto unrecognized ADRs using computational models that integrate pre-clinical screening data with pharmacovigilance data. Logistic regression was used in an embodiment of the invention to avoid potential model overfitting.

Because they frequently involve pharmacologically-relevant compounds and targets, the large-scale compound screening campaigns available from PubChem BioAssay present an attractive data set from which to discover potential drug adversities. Many screens involve targets that belong to families with known pharmacologically active targets but are not themselves drug targets, such as KCNJ2, a potassium channel also known as Kir2.1. This protein is the target for AID 1672, the BioAssay most correlated with the “Nervous system disorders” SOC (see table of FIG. 6).

Mutated forms of KCNJ2 are associated with congenital long QT Syndrome, and many drugs are known to interact with several other members of the family. The approach of an embodiment of the present invention is fundamentally agnostic of the pharmacological characteristics of the screens it evaluates such that screens can be selected that do not involve defined molecular targets or were not intended for drug discovery.

The approach of embodiments of the present invention is based on, among other things, the premise that a fraction of SOC-specific ADRs are at least partly due to drugs interacting with unintended targets (“promiscuity”). These interactions can be detectable in large-scale compound screening campaigns since some of the molecular actors of ADRs must involve interactions at the cellular level and are potentially detectable in such assays. Compound promiscuity in PubChem BioAssay screens has been demonstrated recently, with 25-40% of the compounds in that database exhibiting bioactivity with more than one target. This result is congruent: the molecular targets of the drugs are typically different from the targets used by the BioAssays in the model.

Selectivity and specificity was achieved as follows: half of the models achieved a LOOCV AUC of 0.7 or greater, and all models achieved 0.6 or greater (see table of FIG. 6). This performance is attributable in part to the diversity of screens in the PubChem BioAssay database that provides good odds of identifying screens that share a biological relationship with the ADRs under consideration. This performance is further reflected in the robustness of the models' predictions: 75% of the SOC-specific adversity predictions for approved drugs were corroborated by prior knowledge, mostly involving FDA-sanctioned data (see table of FIG. 7). Suggestive evidence exists in mammals other mammals: Hydroquinone is a skin bleaching agent with an unusual property: it is carcinogenic in murine in vivo bone marrow micronucleus tests but inactive in in vitro mutagenesis tests. For this reason, studies of hydroquinone's potential dermal carcinogenicity in mice and rats were launched by the FDA recently under the National Toxicology Program.

Predictions were generated for three drugs new to the US market or otherwise unapproved for which the models of the present invention could be applied: tranilast, diacerein and nitazoxanide (see table of FIG. 8). No meaningful prior knowledge was found in support of these predictions. Tranilast was approved in 1982 in Japan and South Korea for the treatment of bronchial asthma, yet the model of the present invention predicts adverse reactions in the respiratory system. Tranilast is a synthetic tryptophan metabolite that inhibits the release of histamine, leukotriene-mediated smooth muscle contraction, and collagen synthesis.

Nitazoxanide was approved by the FDA in 2002 and is a member of the thiazolides family, a novel class of drugs for the treatment of protozoan infections such as cryptosporidiosis and giardiasis. Its target is believed to be pyruvate:ferredoxin oxidoreductase (PFOR), an enzyme essential to electron transfer reactions used in anaerobic energy metabolism. A model of an embodiment of the present invention predicts that nitazoxanide has the potential to induce neoplasia. Nitazoxanide and other thiazolides inhibit the enzymatic activity of glutathione-S-transferase μ (GSTP1), a marker of cancer development in many tissues. GSTP is a member of a diverse superfamily frequently overexpressed in multidrug-resistant cancer cells. Therefore, nitazoxanide's potential neoplastic adversity could be related to its apoptotic activity in human colon cancer cells cultured in vitro, as it is believed to inhibit the anti-apoptosis activity of glutathione transferase isozymes within the c-Jun N-terminal kinase (JNK) signaling pathway, a pathway known to control cell proliferation and apoptosis.

Diacerein is an atypical non-steroidal anti-inflammatory drug (NSAID) approved in France for the treatment of osteoarthritis since 1992. A single literature case report associates diacerein with toxic epidermal necrolysis, a syndrome classified under the “Skin and subcutaneous tissue disorders” SOC, the SOC predicted by a model of the present invention. Diacerein directly inhibits the synthesis of interleukin-1 (IL-1) in vitro, and, indirectly, the synthesis of metalloprotease-13 (collagenase-3; MMP-13) in the subchondral bone of osteoarthritic patients. MMP-13 is induced in various skin diseases and mediates cell cycle progression in mouse melanocytes, providing a rationale for a potential role for diacerein in skin diseases.

Embodiments of the present invention provide rational, testable hypotheses that is able to help inform the identification of unrecognized ADRs in a clinical context, shortening the delay during which ADRs go undetected. Embodiments of the present invention can also be applicable within the regulatory framework by better informing surveillance and, eventually, warning statements. Also, within the drug discovery, development, and approval processes, embodiments of the present invention are useful in providing predictive preclinical assays applicable to novel compounds.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application while maintaining substantially the same functionality without departing from the scope and spirit of the present invention.

What is claimed is:

1. A method for analyzing a drug, comprising:
receiving data from a first database, wherein the data from the first database includes marketplace information about effects of the drug;
computing a first set of measures, wherein the first set of measures are for effects of each ingredient of the drug on at least one bodily system of recipient of the drug;
receiving data from a second database, wherein the data from the second database includes experimental information about effects of ingredients of the drug;
computing a second set of measures, wherein the second set of measures are for experimental bioactivity for each compound of the drug;
computing a first set of logistic regression, wherein the first set of logistic regressions is computed for each measure of the first set of measures against each measure of the second set of measures; and
determining a most significant logistic regression.

2. The method of claim 1, wherein the first database is a CVAR database.

3. The method of claim 1, wherein the second database is a PubChem BioAssay database.

4. The method of claim 1, wherein the first set of measures are PRRs for each ingredient of the drug.

5. The method of claim 1, wherein the first set of measures are relative risk ratios.

6. The method of claim 1, wherein the first set of measures are reporting odds ratios.

7. The method of claim 1, wherein second set of measures are Z-scores of bioactivities for each ingredient of the drug.

8. The method of claim 1, further comprising determining a second most significant logistic regression.

9. The method of claim 1, wherein the most significant logistic regression provides an indication of adverse drug effects.

10. The method of claim 1, wherein the most significant logistic regression provides an indication of a benefit of a drug.

11. The method of claim 1, wherein the first database includes information about post-marketing adverse drug effects.

12. The method of claim 1, wherein the second database includes experimental drug screening information.

13. The method of claim 1, wherein the bodily system is an organ system.

14. A computer-readable medium including instructions that, when executed by a processing unit, cause the processing unit to drug analysis, by performing the steps of:
receiving data from a first database, wherein the data from the first database includes marketplace information about effects of the drug;
computing a first set of measures, wherein the first set of measures are for effects of each ingredient of the drug on at least one bodily system of recipient of the drug;
receiving data from a second database, wherein the data from the second database includes experimental information about effects of ingredients of the drug;
computing a second set of measures, wherein the second set of measures are for experimental bioactivity for each compound of the drug;
computing a first set of logistic regression, wherein the first set of logistic regressions is computed for each measure of the first set of measures against each measure of the second set of measures; and
determining a most significant logistic regression.

15. The computer-readable medium of claim 14, wherein the first database is a CVAR database.

16. The computer-readable medium of claim 14, wherein the second database is a PubChem BioAssay database.

17. The computer-readable medium of claim 14, wherein the first set of measures are PRRs for each ingredient of the drug.

18. The computer-readable medium of claim 14, wherein the first set of measures are relative risk ratios.

19. The computer-readable medium of claim 14, wherein the first set of measures are reporting odds ratios.

20. The computer-readable medium of claim 14, wherein second set of measures are Z-scores of bioactivities for each ingredient of the drug.

21. The computer-readable medium of claim 14, further comprising determining a second most significant logistic regression.

22. The computer-readable medium of claim 14, wherein the most significant logistic regression provides an indication of adverse drug effects.

23. The computer-readable medium of claim 14, wherein the most significant logistic regression provides an indication of a benefit of a drug.

24. The computer-readable medium of claim 14, wherein the first database includes information about post-marketing adverse drug effects.

25. The computer-readable medium of claim 14, wherein the second database includes experimental drug screening information.

26. The computer-readable medium of claim 14, wherein the bodily system is an organ system.

27. A computing device comprising:
a data bus;
a memory unit coupled to the data bus;
a processing unit coupled to the data bus and configured to
receive data from a first database, wherein the data from the first database includes marketplace information about effects of the drug;
compute a first set of measures, wherein the first set of measures are for effects of each ingredient of the drug on at least one bodily system of recipient of the drug;
receive data from a second database, wherein the data from the second database includes experimental information about effects of ingredients of the drug;
compute a second set of measures, wherein the second set of measures are for experimental bioactivity for each compound of the drug;
compute a first set of logistic regression, wherein the first set of logistic regressions is computed for each measure of the first set of measures against each measure of the second set of measures; and
determine a most significant logistic regression.
